(19) United States
(12) Patent Application Publication
(10) Pub. No.: US 2017/0249668 A1
(43) Pub. Date: Aug. 31, 2017

(54) SYSTEMS AND METHODS FOR AUTOMATICALLY INSERTING ANNOTATIONS IN ONLINE ADVERTISEMENTS

(71) Applicant: Google Inc., Mountain View, CA (US)

(72) Inventor: Jean-Yves Delort, Dubendorf (CH)

(21) Appl. No.: 14/800,470

(22) Filed: Jul. 15, 2015

(51) Int. Cl. G06Q 30/02; G06F 17/24

(52) U.S. Cl. CPC G06Q 30/0269; G06F 17/241; G06Q 30/0277

(57) ABSTRACT

Systems and methods for automatically enhancing online advertisements by inserting annotations are provided. The system can identify a content serving opportunity to display a content item. The system can, responsive to selection of a content item corresponding to the content serving opportunity, identify candidate annotation types. The system can determine, based on the content serving opportunity and the content item, for each of the candidate annotation types, an annotation type relevancy score indicating a level of relevance of the candidate annotation type to the content serving opportunity. The system can select at least one annotation type of the candidate annotation types based on the annotation type relevancy score. The system can generate, for the selected annotation type, an annotation corresponding to the selected annotation type. The generated annotation can include information related to the content item. The information can be received from a source data feed of the content provider.

### BACKGROUND

In a computer networked environment such as the internet, third-party content providers provide third-party content items for display on end-user computing devices. These third-party content items, for example, advertisements, can be linked to web pages associated with the third-party content providers. These third-party content items can include content identifying the third-party content provider that provided the content item.

### SUMMARY

At least one aspect is directed to a method of automatically enhancing online advertisements by inserting annotations. A data processing system can include one or more processors. The method can include identifying a content serving opportunity to display a content item on a computing device. The method can include identifying, responsive to selection of a content item corresponding to the content serving opportunity, one or more candidate annotation types according to which to generate annotations for display with the content item. The method can include determining, based on the content serving opportunity and the content item, for each of the candidate annotation types, an annotation type relevancy score indicating a level of relevance of the candidate annotation type to the content serving opportunity. The method can include selecting at least one annotation type of the one or more of candidate annotation types based on the relevancy score of the at least one annotation type. The method can include generating, for the selected at least one annotation type, at least one annotation corresponding to the selected annotation type, the at least one annotation including information related to the content item. The information can be received from a source data feed of the content provider that is associated with a previously established content serving campaign of the content provider. The content item can belong to a second content serving campaign different from the previously established content serving campaign. The method can include providing the generated at least one annotation for display with the content item at the computing device.

In some implementations, the method can include identifying third-party content from a database based on the selected content item. In some implementations, identifying one or more candidate annotation types according to which to generate annotations for display with the content item further can include identifying the one or more candidate annotation types based on the third-party content. In some implementations, identifying the third-party content from the database based on the selected content item can include identifying the third-party content from the database based on content item auction parameters.

In some implementations, the method can include identifying, for a content provider having a campaign, a setting to automatically enhance one or more content items for the campaign based on pre-existing data. In some implementations, identifying the one or more candidate annotation types can include identifying the one or more candidate annotation types, responsive to identifying the setting to automatically enhance the one or more content items for the campaign, based on the pre-existing data.

In some implementations, the one or more of the candidate annotation types can include at least one of a click to call annotation to allow the computing device to initiate a phone call, a click for directions annotation to display a map having directions on the computing device, and a click to order annotation to initiate a purchase order on the computing device. In some implementations, the content item can include a video advertisement. In some implementations, the content serving opportunity can include a device type of the computing device, a location identifier of the computing device, a time of day, and an industry relating to the content provider.

In some implementations, determining the annotation type relevancy score can include determining a predicted conversion rate for each of the candidate annotation types. In some implementations, determining the annotation type relevancy score can include determining the annotation type relevancy score for each of the candidate annotation types based the predicted conversion rate for the respective candidate annotation type. In some implementations, determining the predicted conversion rate for each of the candidate annotation types can include determining the predicted conversion rate for each of the candidate annotation types based on a correlation between a primary content associated with the content item and content of each of the candidate annotation types.

At least one aspect is directed to a system for automatically enhancing online advertisements by inserting annotations. The system can comprise a data processing system having one or more processors. The data processing system can be configured to identify a content serving opportunity to display a content item on a computing device. The data processing system can be configured to identify, responsive to selection of a content item corresponding to the content serving opportunity, one or more candidate annotation types according to which to generate annotations for display with the content item. The data processing system can be configured to determine, based on the content serving opportunity and the content item, for each of the candidate annotation types, an annotation type relevancy score indicating a level of relevance of the candidate annotation type to the content serving opportunity. The data processing system can be configured to select at least one annotation type of the one or more of candidate annotation types based on the annotation type relevancy score of the at least one annotation type. The data processing system can be configured to generate for the selected at least one annotation type, at least one annotation corresponding to the selected annotation type, the at least one annotation including information related to the content item. The information can be received from a source data feed of the content provider that is associated with a previously established content serving campaign. The content item can belong to a second content serving campaign different from the previously established content serving campaign. The data processing system can be configured to provide the generated at least one annotation for display with the content item at the computing device.

In some implementations, the data processing system can be configured to identify third-party content from a database based on the selected content item. In some implementations, identifying one or more candidate annotation types according to which to generate annotations for display with the content item further can include identifying the one or more candidate annotation types based on the third-party content. In some implementations, identifying the third-party content from the database based on the selected content item can include identifying the third-party content from the database based on content item auction parameters.

In some implementations, the data processing system can be configured to identify, for a content provider having a campaign, a setting to automatically enhance one or more content items for the campaign based on pre-existing data. In some implementations, identifying the one or more candidate annotation types can include identifying the one or more candidate annotation types, responsive to identifying the setting to automatically enhance the one or more content items for the campaign, based on the pre-existing data.

In some implementations, the one or more of the candidate annotation types can include at least one of a click to call annotation to allow the computing device to initiate a phone call, a click for directions annotation to display a map having directions on the computing device, and a click to order annotation to initiate a purchase order on the computing device. In some implementations, the content item can include a video advertisement. In some implementations, the content serving opportunity can include a device type of the computing device, a location identifier of the computing device, a time of day, and an industry relating to the content provider.

In some implementations, determining the annotation type relevancy score can include determining a predicted conversion rate for each of the candidate annotation types. In some implementations, determining the annotation type relevancy score can include determining the annotation type relevancy score for each of the candidate annotation types based the predicted conversion rate for the respective candidate annotation type. In some implementations, determining the predicted conversion rate for each of the candidate annotation types can include determining the predicted conversion rate for each of the candidate annotation types based on a correlation between a primary content associated with the content item and content of each of the candidate annotation types.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one implementation of an environment for auto-enhancing content items for display on communication devices in a computer network environment, according to an illustrative implementation;

FIGS. 2A-2C are displays depicting auto-enhanced content items, according to an illustrative implementation;

FIG. 3 is a display depicting a user interface for an advertisement campaign manager, according to an illustrative implementation;

FIG. 4 is a flow diagram depicting a method of auto-enhancing content items, according to an illustrative implementation; and

FIG. 5 is a block diagram illustrating a general architecture for a computer system that may be employed to implement elements of the systems and methods described and illustrated herein, according to an illustrative implementation.

### DETAILED DESCRIPTION

Following below are more detailed descriptions of various concepts related to, and implementations of, methods, apparatuses, and systems of automatically enhancing content items by inserting annotations for display at computing devices in a computer network environment. The various concepts introduced above and discussed in greater detail below may be implemented in any of numerous ways, as the described concepts are not limited to any particular manner of implementation.

Advertisers may serve dynamic advertisements to increase brand awareness as well as provide more relevant content to users. A dynamic advertisement can include supplemental content that is specifically generated based on one or more parameters of a content serving opportunity. The content serving opportunity can include one or more parameters that are used to select the particular advertisement. Examples of content serving parameters can include a time of day, a type of device, an identifier identifying a user of the computing device, a search query, among others. The dynamic ad can be generated in real-time based on one or more parameters of the content serving opportunity. The supplemental content included in the dynamic advertisement can be generated from data included in a source data feed. The advertiser can select the data to be included in the source data feed.

In some implementations, the supplemental content can include content items related to products or services of the advertiser that the advertiser may include in a source data feed. As an example, when a user visits a particular webpage and an ad is requested, a dynamic ad can be served that includes a product title and description of a product of the advertiser that the advertiser has included in the source data feed.

Advertisers may set up dynamic advertising campaigns. In some such campaigns, the advertiser manually generates or populates the source data feed by identifying one or more products or services to include in the source data feed. These dynamic advertisement campaigns are, however, limited to generating display ads.

Other types of ad formats, such as video ads, are served by setting up ad campaigns specific to the ad format. At present, to serve video ads with additional information about products or services of the advertiser, the advertiser may either manually insert annotations that include the additional information or use some semi- automated process in which an advertiser can be prompted to provide additional information when setting up or modifying a video ad campaign.

One challenge with these manual and semi-automatic approaches is that they require a user to set up a whole new dynamic advertisement campaign for other ad formats or create a new dynamic advertisement extension, both of which are complex, labor intensive processes that require the user to enter additional information. In particular, to set up a dynamic ad campaign, the advertiser may have to set up a source data feed, which identifies products or services that the advertiser wishes to include in the ads. Furthermore, creating a new dynamic extension requires frontend and backend changes to the advertisement campaign itself.

The systems and methods described herein can leverage pre-existing information regarding the advertiser from the advertiser's existing dynamic advertising campaigns or relevant data from other third party sources to generate supplemental content to insert in ads. In some aspects, the technology may relate to methods and systems for automatically identifying dynamic content settings in existing advertisement campaigns of an advertiser and using the settings to create dynamic advertisements. Using this technology, the system can automatically insert supplemental content into ads at serving time to provide additional relevant content.

In some implementations, the technology can be implemented in two or more steps. The first step can include identifying dynamic content parameters and other settings specified by the advertiser in one or more existing advertising campaigns or relevant data from third party sources. Existing advertising campaigns can include dynamic campaigns and also other campaigns such as static text ad campaigns, display ad campaigns, among others.

The second step can include using the dynamic content parameters and other settings to generate and insert annotations for the advertisement. In some implementations, the second step can include inserting the annotations automatically into the ad at serving time. In some other implementations, the second step can include the system prompting the advertiser for confirmation of the identified information that has been automatically filled into the fields of the campaign manager before generating the annotations for insertion in the ad.

As an example, a retailer can use this invention to create an advertisement (e.g., “dynamic video ad”) for the retailer's products. The dynamic video ad can include annotations inserted within a video advertisement of the retailer. A video advertisement annotation system can identify information from pre-existing sources, such as merchant identification, remarketing campaigns, shopping campaigns, and keywords for the video ad. Using the identified information, the video advertisement annotation system can insert in the video ad, an annotation that contains an interactive content item, for example, a clickable advertisement for one of the retailer's products or store locations. Other examples of annotations include movie times at local theaters for a movie advertisement and recommended books for kids for a clothing advertisement targeted towards children.

The present disclosure relates to methods and systems of automatically enhancing online advertisements by inserting annotations. A data processing system including one or more processors can identify a content serving opportunity to display a content item on a computing device. Responsive to selection of a content item corresponding to the content serving opportunity, the data processing system can identify one or more candidate annotation types according to which to generate annotations for display with the content item. The data processing system can determine, based on the content serving opportunity and the content item, for each of the candidate annotation types, an annotation type relevancy score indicating a level of relevance of the candidate annotation type to the content serving opportunity. The data processing system can select at least one annotation type of the one or more of candidate annotation types based on the relevancy score of the at least one annotation type. The data processing system can generate, for the selected at least one annotation type, at least one annotation corresponding to the selected annotation type. The at least one annotation can include information related to the content item. The data processing system can provide the generated at least one annotations for display with the content item at the computing device.

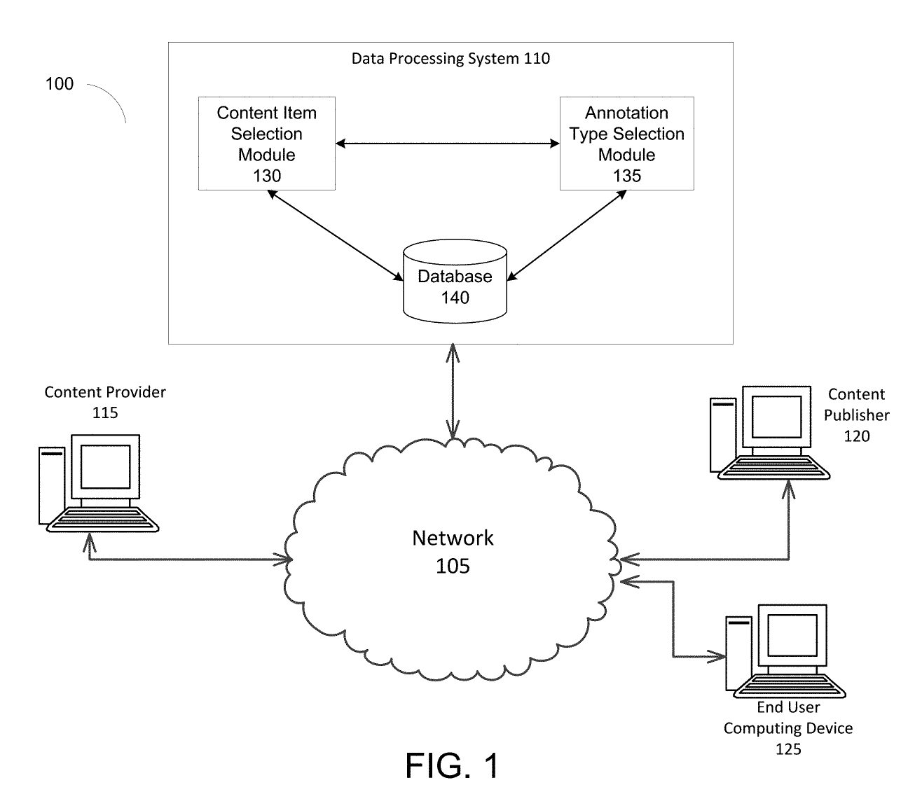

FIG. 1 is a block diagram depicting one implementation of an environment for automatically enhancing online advertisements by inserting annotations. The environment 100 includes at least one data processing system 110. The data processing system 110 can include at least one processor and a memory, i.e., a processing circuit. The memory stores processor-executable instructions that, when executed by processor, cause the processor to perform one or more of the operations described herein. The processor may include a microprocessor, application-specific integrated circuit (ASIC), field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions may include code from any suitable computer-programming language. The data processing system can include one or more computing devices or servers that can perform various functions. In some implementations, the data processing system can include an advertising auction system configured to host auctions. In some implementations, the data processing system does not include the advertising auction system but is configured to communicate with the advertising auction system via the network 105.

The network 105 can include computer networks such as the internet, local, wide, metro or other area networks, intranets, satellite networks, other computer networks such as voice or data mobile phone communication networks, and combinations thereof. The data processing system 110 of the system 100 can communicate via the network 105, for instance with at least one content provider computing device 115, at least one content publisher computing device 120, or at least one end user computing device 125. The network 105 may be any form of computer network that relays information between the user computing device 115, data processing system 110, and one or more content sources, for example, web servers, advertising servers, amongst others. For example, the network 105 may include the Internet and/or other types of data networks, such as a local area network (LAN), a wide area network (WAN), a cellular network, satellite network, or other types of data networks. The network 105 may also include any number of computing devices (e.g., computer, servers, routers, network switches, etc.) that are configured to receive and/or transmit data within network 105. The network 105 may further include any number of hardwired and/or wireless connections. For example, the user computing device 115 may communicate wirelessly (e.g., via WiFi, cellular, radio, etc.) with a transceiver that is hardwired (e.g., via a fiber optic cable, a CATS cable, etc.) to other computing devices in network 105.

The content provider computing devices 115 can include servers or other computing devices operated by a content provider entity to provide content items such as advertisements for display on information resources at the end user computing device 125. The content provided by the content provider computing device 115 can include third party content items or creatives (e.g., ads) for display on information resources, such as a website or web page that includes primary content, e.g. content provided by the content publisher computing device 120. The content items can also be displayed on a search results web page. For instance, the content provider computing device 115 can provide or be the source of ads or other content items for display in content slots of content web pages, such as a web page of a company where the primary content of the web page is provided by the company, or for display on a search results landing page provided by a search engine. The content items associated with the content provider computing device 115 can be displayed on information resources other than web pages, such as content displayed as part of the execution of an application on a smartphone or other end user computing device 125.

The content publisher computing devices 120 can include servers or other computing devices operated by a content publishing entity to provide primary content for display via the network 105. For instance, the content publisher computing device 120 can include a web page operator who provides primary content for display on the web page. The primary content can include content other than that provided by the content publisher computing device 120, and the web page can include content slots configured for the display of third party content items (e.g., ads) from the content provider computing devices 115. For instance, the content publisher computing device 120 can operate the website of a company and can provide content about that company for display on web pages of the website. The web pages can include content slots configured for the display of third party content items such as ads of the content provider computing device 115. In some implementations, the content publisher computing device 120 includes a search engine computing device (e.g. server) of a search engine operator that operates a search engine website. The primary content of search engine web pages (e.g., a results or landing web page) can include results of a search as well as third party content items displayed in content slots such as content items from the content provider computing device 115. In some implementations, the content publisher computing device 120 can include a server for serving video content.

The end user computing devices 125 can include computing devices configured to communicate via the network 105 to display data such as the content provided by the content publisher computing device 120 (e.g., primary web page content or other information resources) and the content provided by the content provider computing device 115 (e.g., third party content items such as ads configured for display in a content slot of a web page). The end user computing device 125, the content provider computing device 115, and the content publisher computing device 120 can include desktop computers, laptop computers, tablet computers, smartphones, personal digital assistants, mobile devices, consumer computing devices, servers, clients, digital video recorders, a set-top box for a television, a video game console, or any other computing device configured to communicate via the network 105. The end user computing devices 125 can be communication devices through which an end user can submit requests to receive content. The requests can be requests to a search engine and the requests can include search queries. In some implementations, the requests can include a request to access a web page.

The content provider computing devices 115, the content publisher computing device 120 and the end user computing devices 125 can include a processor and a memory, i.e., a processing circuit. The memory stores machine instructions that, when executed by processor, cause processor to perform one or more of the operations described herein. The processor may include a microprocessor, application-specific integrated circuit (ASIC), field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions may include code from any suitable computer-programming language.

The content provider computing devices 115, the content publisher computing devices 120, and the end user computing devices 125 may also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of the content provider computing devices 115, the content publisher computing device 120 and the end user computing devices 125 (e.g., a built-in display, microphone, etc.) or external to the housing of content provider computing devices 115, the content publisher computing device 120 and the end user computing devices 125 (e.g., a monitor connected to the user computing device 115, a speaker connected to the user computing device 115, etc.), according to various implementations. For example, the content provider computing devices 115, the content publisher computing device 120 and the end user computing devices 125 may include an electronic display, which visually displays web pages using webpage data received from one or more content sources and/or from the data processing system 110 via the network 105. In some implementations, a content placement campaign manager or third-party content provider, such as an advertiser, can communicate with the data processing system 110 via the content provider computing devices 115. In some implementations, the advertiser can communicate with the data processing system 110 via a user interface displayed on the user interface devices of the content provider computing devices 115.

The data processing system 110 can include at least one server. For instance, the data processing system 110 can include a plurality of servers located in at least one data center or server farm. In some implementations, the data processing system 110 includes a content placement system, e.g., an ad server or ad placement system. The data processing system 110 can include at least one content item selection module 130, at least one annotation type selection module 135, and at least one database 140. The content item selection 130 and the annotation type selection module 135 each can include at least one processing unit, server, virtual server, circuit, engine, agent, appliance, or other logic device such as programmable logic arrays configured to communicate with the database 140 and with other computing devices (e.g., the content provider computing device 115, the content publisher computing device 120, or the end user computing device 125) via the network 105.

The content item selection module 130 and the annotation type selection module 135 can include or execute at least one computer program or at least one script. The content item selection module 130 and the annotation type selection module 135 can be separate components, a single component, or part of the data processing system 110. The content item selection module 130 and the annotation type selection module 135 can include combinations of software and hardware, such as one or more processors configured to execute one or more scripts to: (a) identify a content serving opportunity to display a content item on a computing device; (b) responsive to selection of a content item corresponding to the content serving opportunity, identify one or more candidate annotation types according to which to generate annotations for display with the content item; (c) determine, based on the content serving opportunity and the content item, for each of the candidate annotation types, an annotation type relevancy score indicating a level of relevance of the candidate annotation type to the content serving opportunity; (d) select at least one annotation type of the one or more of candidate annotation types based on the relevancy score of the at least one annotation type; (e) generate for the selected at least one annotation type, at least one annotation corresponding to the selected annotation type, the at least one annotation including information related to the content item; and (f) provide the generated at least one annotation for display with the content item at the computing device.

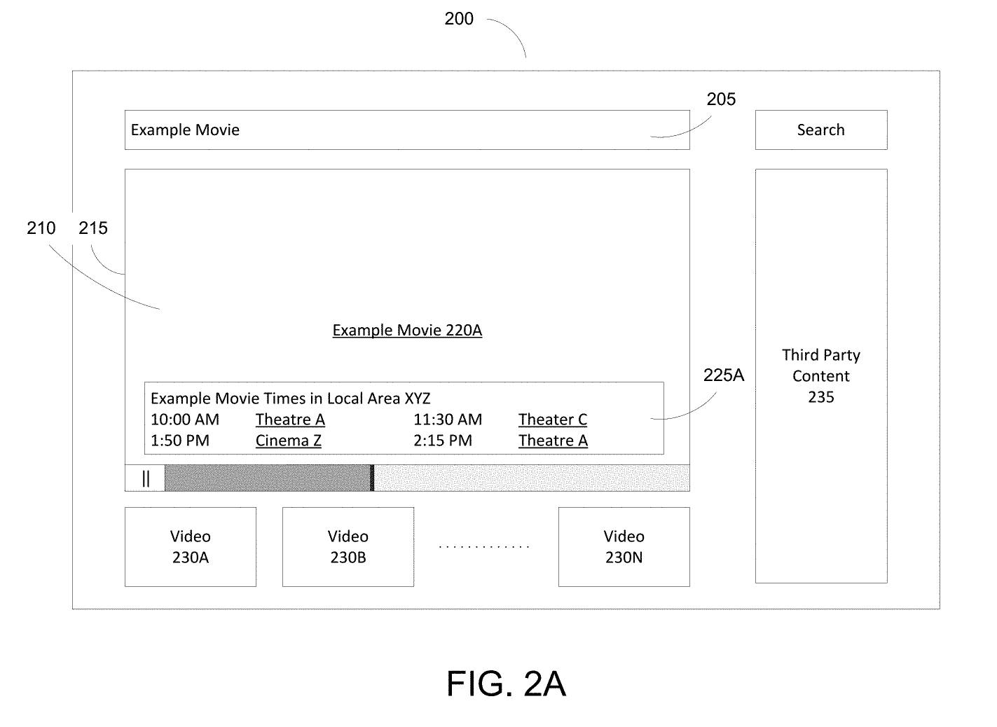

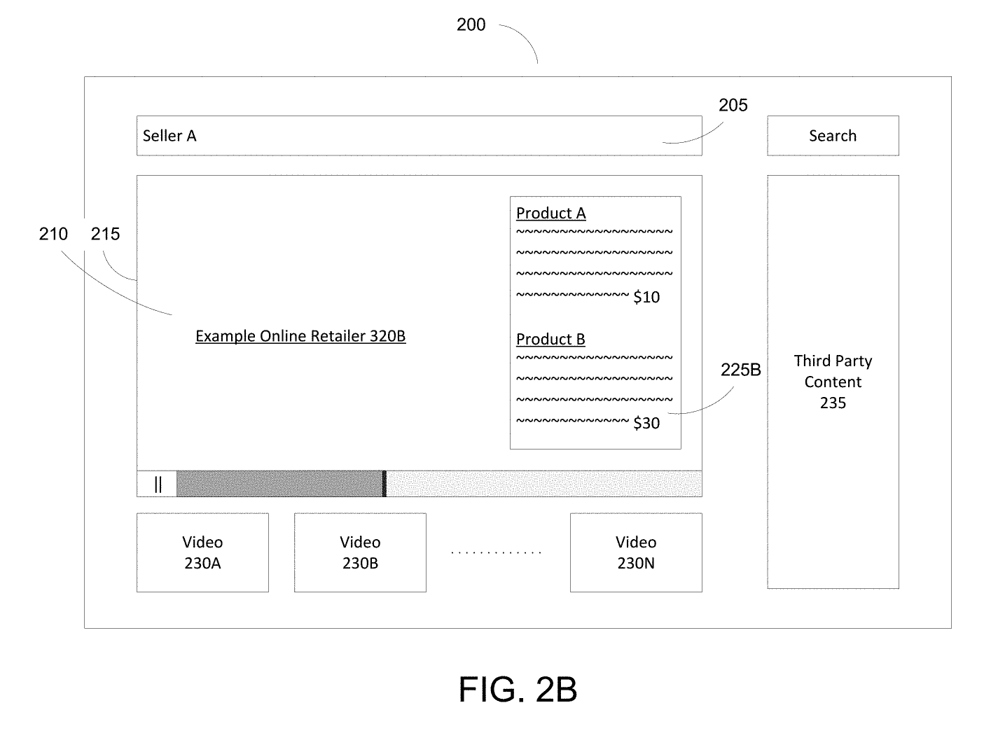

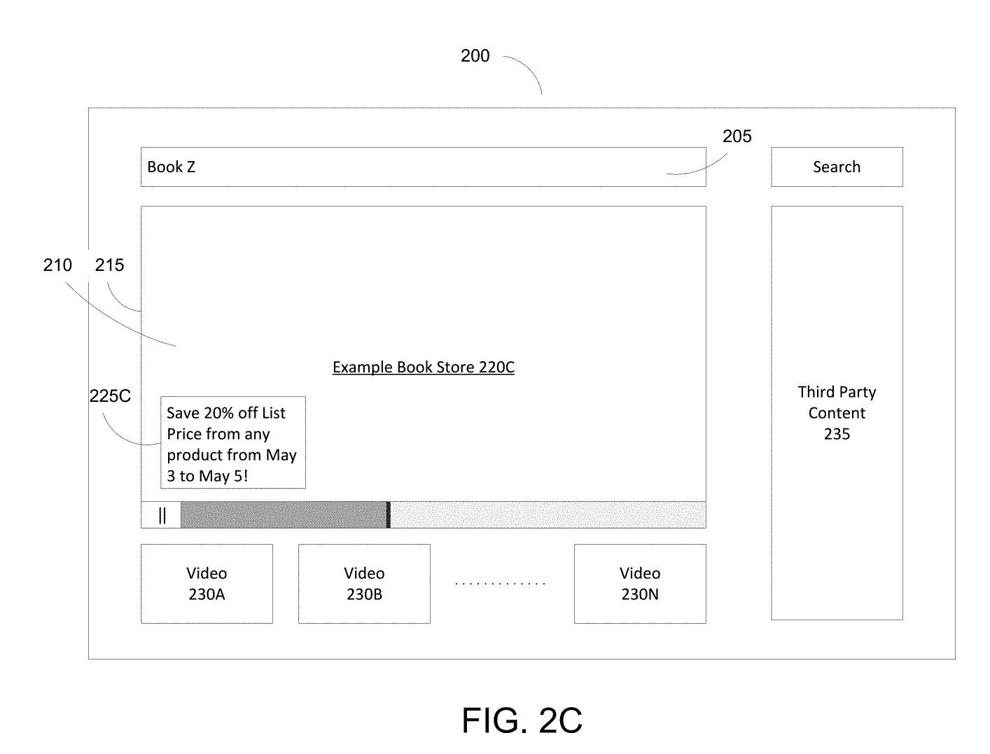

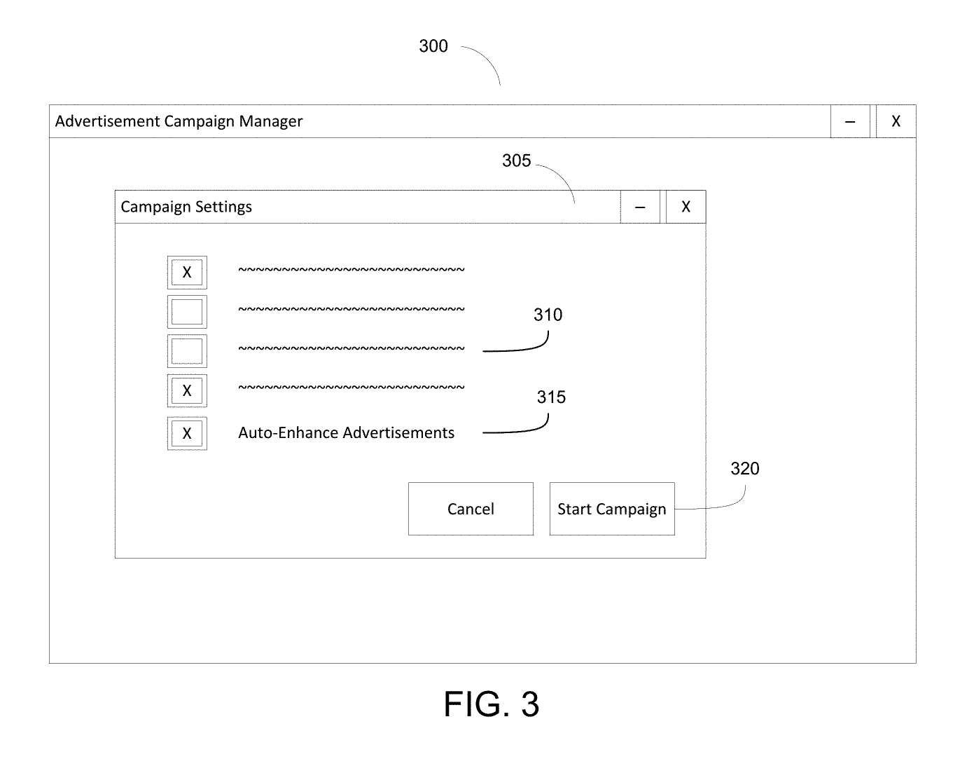

The data processing system 110 can also include one or more content repositories or databases 140. The databases 140 can be local to the data processing system 110. In some implementations, the databases 140 can be remote to the data processing system 110 but can communicate with the data processing system 110 via the network 105. The databases 140 can include web page, content items (e.g., advertisements), primary video content, an advertisement campaign manager, content provider feed, third party content, and annotations, among others, to serve to an end user computing device 125. In some implementations, the web page, content items, primary video content, an advertisement campaign manager, content provider feed, third party content, and annotations can include those illustratively depicted in FIGS. 2A-2C and 3. Additional details of the contents of the database 140 will be provided below.

The content item selection module 130 can be configured to identify a content serving opportunity to display a content item on an end user computing device 125. The content item can include a video ad, a static ad, a text ad, a dynamic ad, among others. The content item can be displayed on a display of the end user computing device 125. In some implementations, the content item can be displayed in a content slot or ad slot in a web page that is displayed at a display of the end user computing device 125. The content serving opportunity can include any parameter that may be used to select at least one content item from a plurality of content items for display on the end user computing device 125. In some implementations, a content serving opportunity may relate to any opportunity to serve an ad. The content serving opportunity can include one or more parameters that can be used by a server of the ad selection system to select an ad for display. The parameters can be specific to the request. Examples of parameters that can be used can include a time of day, a type of device, an identifier associated with the request, information associated with primary content with which to serve the ad, and one or more keywords corresponding to the opportunity, among others. In some implementations, when a user requests to receive content, a request to identify one or more ads for serving with the content can be generated. The requests can include information about the webpage on which to serve the ad, information about the user to whom the ad is to be served, information about the device on which the ad is to be served, geographic information of the user, and interests of the user, among others.

In some implementations, the content item selection module 130 can be configured to identify a content serving opportunity to display a content item, such as an ad, on an end user computing device 125, responsive to receiving a request for content from the end user computing device 125. For example, when the end user computing device 125 sends a request for an online document that includes content slots to the content item selection module 130, the content item selection module 130 can identify content serving opportunities to display a respective content item in each of the content slots.

In some implementations, the content serving opportunity can include one or more content item auction parameters and the primary content on which the content item is to be displayed. The content item auction parameters can include bid values for various content providers 115 to place content items, such as advertisements, on a web page of the content publisher 120. Content item auction parameters can also include specified search queries for which to serve the content item with or keywords related to the specified search queries. The primary content on which the content item is to be displayed can include an information resource, which can include one or more of an online document, web page, mobile app page, video player, among others. In one example, if content item A is about a new movie and content item B is about a new skateboard, and the primary content on which the content item is to be displayed is a film critic blog, the content item selection module 130 can select content item A about the new movie responsive to determining that content item A is more relevant to the content item than content item B.

In some implementations, the content serving opportunity can include at least one of a device type of the end user computing device 125, a location identifier of the end user computing device 125, a time of day, and an industry relating to the content provider 115. For example, suppose the device type of the end user computing device 125 is a mobile smartphone, the location identifier of the end user computing device 125 indicates that the mobile smartphone is in the financial district of a large metropolitan municipality, and the time of day is 11:35 am. Further suppose that there is content item A associated with a food truck and content item B associated with tractors for farms. In this example, the content item section module 130 can identify the content serving opportunity for content item A to serve to the mobile smartphone as including the location of the mobile smartphone being in the financial district of a large metropolitan municipality and the time of day being 11:35 am.

Responsive to selection of a content item corresponding to the content serving opportunity, the annotation type selection module 135 can be configured to identify one or more candidate annotation types according to which to generate annotations for display with the content item. The one or more candidate annotation types can include at least one of a click to call annotation to allow the end user computing device 125 to initiate a phone call, a click for directions annotation to display a map having directions on the end user computing device 125, a click to order annotation to initiate a purchase order on the end user computing device 125, and a display annotation of the products or services advertised by the content provider 115, among others.

The annotation type selection module 135 can be configured to identify one or more candidate annotation types based on annotation type selection parameters. The annotation type selection parameters can include one or more parameters that can be used by the annotation type selection module 135 to identify or otherwise select at least one of the one or more candidate annotation types. In some implementations, the annotation type selection parameters can include any information relevant to identifying or otherwise selecting the one or more candidate annotation types and the content of the one or more annotations corresponding to the respective annotation types. In some implementations, the annotation type selection parameters can include information relating to the primary content on which the content item is to be displayed, identifier information, and request specific parameters that are specific to the request for the content item. Identifier information can include device identifier, location identifier, account identifier, remarketing list data in among others. Request specific parameters can include time of day, day of week, and time of year, search query or associated keywords leading to the request, among others. In some implementations, the request specific parameters can be generated by the annotation type selection module 135 when a user requests to receive content or when the server of the ad selection system selects a content item for display.

In some implementations, the annotation type selection module 135 can be configured to access the annotation type selection parameters from a database 140 responsive to the selection of the content item corresponding to the content serving opportunity. In some implementations, the annotation type selection module 135 can be configured to determine the annotation type selection parameters based on the content serving opportunity. In some implementations, responsive to the selection of the content item corresponding to the content serving opportunity, the annotation type selection module 135 can be configured to receive, retrieve, or otherwise access the content serving opportunity as the annotation type selection parameters. For example, suppose the server of the ad selection system has selected an advertisement for hockey team “Z” located in state XY. Further suppose that the content serving parameters indicate that the primary content is a sports related website, the location identifier indicates that the device that the advertisement is served is in state XY, and the month of year is winter. In this example, the annotation type selection module 135 can receive the content serving parameters as the annotation type selection parameters.

The annotation type selection module 135 can be configured to determine, based on the content serving opportunity and the content item, for each of the candidate annotation types, an annotation type relevancy score indicating a level of relevance of the candidate annotation type to the content serving opportunity. In some implementations, the annotation type selection module 135 can be configured to determine the annotation type relevancy score based on the content item, annotation type selection parameters, primary content on which the content item is to be displayed, and the specifications of the end user computing device 125, among others, or any combination thereof. In some implementations, the annotation type selection module 135 can be configured to assign or otherwise determine a numerical weight based on a function of the content item, annotation type selection parameters, primary content on which the content item is to be displayed, and the specifications of the end user computing device 125.

In some implementations, the annotation type selection module 135 can be configured to determine the annotation type relevancy score based on the content item and the candidate annotation type. For example, suppose the content item is a static text advertisement and includes a reference to a particular menu item at a restaurant franchise. Further suppose that the candidate annotation type is a display annotation containing short text descriptions of other menu items. In this example, the annotation type selection module 135 can determine the annotation type relevancy score based on the correlation between the contents of the content item and the candidate annotation type by correlating similar or identical words and phrases on the content item and the candidate annotation type using semantic analysis algorithms.

In some implementations, the annotation type selection module 135 can be configured to determine the annotation type relevancy score based on the annotation type selection parameters. For example, suppose the content serving opportunity includes a search query specific to the request for content for “directions to ski park Y.” In this example, the annotation type selection module 135 can assign a higher annotation type relevancy score to a click for directions annotation type than a display annotation type based on the search query included in the content serving opportunity.

In some implementations, the annotation type selection module 135 can be configured to determine the annotation type relevancy score based on the primary content on which the content item is to be displayed. In some implementations, the annotation type selection module 135 can be configured to determine the type of primary content. For example, suppose the primary content is a furniture store's webpage and the content item selected for display on the primary content are advertisements for lamps displayed. In this example, the annotation type selection module 135 can determine that the furniture store's webpage is a primary content of the content publisher 120 associated with the content provider 115. Based on this determination, the annotation type selection module 135 can assign a higher annotation type relevancy score to a click to order annotation.

In some implementations, the annotation type selection module 135 can be configured to identify the specifications of the end user computing device 125. The specifications of the end user computing device 125 can include a device identifier associated with the end user computing device 125, location identifier associated with the end user computing device 125, device type of the end user computing device 125, and device capability of the end user computing device 125, among others. The device capability or capabilities of the end user computing device 125 can include any property of the end user computing device 125 itself, such as the operating system, hardware specifications, ability to make phone calls, display window size, and whether the audio has been muted, among others.

In some implementations, the annotation type selection module 135 can be configured to assign a numerical weight for each of the one or more candidate annotation types based on the specifications of the end user computing device 125 and the respective candidate annotation type. For example, suppose for an advertisement of a jewelry store, candidate annotation type A is a click to call annotation to allow the computing device to initialize a phone call and candidate annotation type B is a display of merchandise sold at the jewelry store. Further suppose the primary content on which the content item is to be displayed is an online newspaper article, and the device type of the end user computing device 125 is a tablet without telephone call capabilities. In this example, the annotation type selection module 135 can determine the annotation type relevancy score for display of merchandise sold at the jewelry store and the annotation type relevancy score for the click to call annotation, using a greater numerical weight for the display of merchandise sold at the jewelry store based on the device of the end user computing device 125 being a tablet without telephone call capabilities.

In some implementations, the annotation type selection module 135 can be configured to determine a predicted conversion rate for each of the candidate annotation types. The predicted conversion rate can include one or more of a predicted click through rate, a predicted view through rate, among others. The predicted click through rate can include a function of an expected number of clicks and an expected number of impressions, among others. The predicted view through rate can include a function of an expected post-impression response rate and an expected number of impressions, among others. In some implementations, the annotation type selection module 135 can be configured to determine the annotation type relevancy score for each of the candidate annotation types based on the predicted conversion rate for the respective candidate annotation type.

In some implementations, the annotation type selection module 135 can be configured to determine a predicted conversion rate for each of the candidate annotation types based on prior performance metrics. In some implementations, the annotation type selection module 135 can be configured to access the prior performance metrics from the database 140. In some implementations, the annotation type selection module 135 can be configured to access prior performance metrics corresponding to the each of the candidate annotation types. In some implementations, the prior performance metrics corresponding to the respective candidate annotation type can be associated with at least one of the specifications of the end user computing device 125.

In some implementations, the annotation type selection module 135 can be configured to adjust or otherwise apply a multiplicative or additive factor to the prior performance metrics corresponding to the respective candidate annotation type based on at least one of the specifications of the end user computing device 125 to determine the predicted conversion rate. For example, suppose the content item selected is for a televised comedy show, the location identifier of the end user computing device 125 indicates that the end user computing device 125 is in a suburban area, and the time of day is 10:00 pm. Further suppose that prior performance metrics of the identified candidate annotation type indicate that the view through rate of the candidate annotation type is 0.3% across all locations where the candidate annotation type was previously displayed with the selected content item. In addition, suppose that the television viewing behavior statistics varies throughout different times of the day. In this example, the annotation type selection module 135 can determine the predicted conversion rate based on the prior performance metric of 0.3% view through rate adjusted by the television viewing behavior statistics of the suburban area.

In some implementations, the annotation type selection module 135 can be configured to determine the predicted conversion rate for each of the candidate annotation types based on a correlation between the primary content associated with the content item and content of each of the candidate annotation types. In some implementations, that annotation type selection module 135 can be configured to access the database for a plurality of correlated words. For example, suppose the primary content includes an article that includes several instances of the phrase “deep dish pizza” and the content item selection module 130 has already selected a content item for a pizza chain. Further suppose that candidate annotation type A is a click for directions annotation and that candidate annotation type B is a display annotation with the pizza chain's various menu items. The annotation type selection module 135 can determine that the correlation between the phrase “deep dish pizza” included in the primary content to the content of candidate annotation type A and the content of candidate annotation type B based on the information contained in the candidate annotation type A and candidate annotation type B. The annotation type selection module 135 can determine the correlation between the search query and the information contained in the candidate annotation types using various algorithms such as semantic analysis, semantic correlation, sparse word graphs, and topic modeling, among others. In this example, the annotation type selection module 135 can access the database 140 for a list of words or phrases correlated with the phrase “deep dish pizza.”

The annotation type selection module 135 can be configured to select at least one annotation type of the one or more of candidate annotation types based on the relevancy score of the at least one annotation type. In some implementations, the annotation type selection module 135 can be configured to rank the one or more candidate annotation types based on the relevancy scores for each of the one or more candidate annotation types. In some implementations, responsive to ranking the one or more candidate annotation types based on the relevancy scores for each of the one or more candidate annotation types, the annotation type selection module 135 can be configured to select at least one annotation type of the one or more of candidate annotation types with the highest annotation type relevancy score.

The annotation type selection module 135 can be configured to generate, create, or otherwise render, for the selected at least one annotation type, at least one annotation corresponding to the selected annotation type. The at least one annotation can include information related to the content item. The information can be received from a source data feed of the content provider that is associated with a previously established content serving campaign. In some implementations, the content item can belong to or be otherwise associated with a second content serving campaign different from the previously established content serving campaign. In some implementations, the annotation type selection module 135 can be configured to render, for display, the at least one annotation corresponding to the selected annotation type.

In some implementations, the annotation type selection module 135 can be configured to access at least one annotation template stored at the database 140 to generate or render the selected at least one annotation. In some implementations, the annotation template can specify a location and size of the annotation to be displayed on the content item, a type of content item on which the annotation is to be displayed, and duration that the annotation is to be displayed. For example, suppose a template specifies that the annotation is to be displayed generally along the top of a content item and the type of content item on which the annotation is to be displayed is a static banner advertisement. Further suppose that the selected candidate annotation type is a click to call annotation. In this example, the annotation type selection module 135 can render the click to call annotation with the phone number of the content provider 115 based on the corresponding selected candidate annotation type to be displayed along the top of the static banner advertisement.

The annotation type selection module 135 can be configured to provide the generated at least one annotation for display with the content item at the end user computing device 125. In some implementations, the annotation type selection module 135 can be configured to retrieve the generated at least one annotation for display with the content item at the end user computing device 125, responsive to receiving a request for content or responsive to the selection of the content item. In some implementations, the annotation type selection module 135 can be configured to provide each of the generated annotations for display with the content item at the end user computing device 125 at predetermined times.

In some implementations, annotation type selection module 135 can be configured to provide the generated at least one annotation for display at different locations on the content item in accordance to the annotation template. In some implementations, the annotation type selection module 135 can be configured to identify the different locations based on edge detection of the underlying image of the content item. For example, the annotation type selection module 135 can identify negative space, such as white space or black space, within the content item as a location at which to provide the generated annotation. In some implementations, the annotation type selection module 135 can be configured to identify which of the different locations on the content item has the highest predicted click through rate. For example, the annotation type selection module 135 can perform A/B testing and aggregate the results to determine highest predicted click through rate. In some implementations, the annotation type selection module 135 can be configured to select at least one of the different locations on the content item to provide the generated at least one annotation for display based on determined highest predicted click through rate.

Referring to FIGS. 2A-2C, FIGS. 2A-2C are displays depicting auto- enhanced content items, according to an illustrative implementation. In brief overview, FIGS. 2A-2C each show an example of an auto-enhanced video advertisement, and include a web page 300, search query textbox 205, video 210, video player 215, a video advertisement 220A-220C, annotation 225A-225C, a list of videos 220A-220C, and third party content 225 displayed at a display of the end user computing device 125. The search query textbox 205 can be configured to receive input for a search query for content. The video player 215 can be configured to play the video 210 using buttons generally along the bottom of the video player 215 interface. The video 210 can include video advertisements 220A-220C. Video advertisements 220A-220C can include annotations 225A-225C. Videos 220A-220C can include hyperlinks to other videos depicted therein. Third party content 225 can include content items provided by the content provider 115 or content publisher 120, and can include a static advertisement, animated advertisement, another video advertisement, and audiovisual advertisement, among others. FIGS. 2A-2C are for illustrative purposes, as the generated at least one annotation for display can be displayed in any number of user interface environments, for example, on a static banner advertisement on a web page without a video player. Furthermore, in some implementations, the video advertisements 220A-220C can be selected outside the context of search queries.

In further detail, in FIG. 2A, the term “Example Movie” is queried using the search query textbox 205. In this example, suppose that the location identifier of the end user computing device 125 indicates that the end user computing device 125 is in a town named “XYZ.” The selected content item is a video advertisement 220A for an Example Movie trailer. The annotation 225A appears generally along the bottom of the video player 215, and lists some of the times that Example Movie is being shown at various locations in the local area of the town “XYZ.” The times that Example Movie is being shown at various location in the local area of the town “XYZ” can be accessed from third-party content stored at the database 140. In annotation 225A, the location names may be hyperlinks (as indicated in underline) to the website of the respective location that once clicked will cause the browser on which the web page 300 is displayed at the end user computing device 125 to receive another web page indicated by the respective hyperlink.

In FIG. 2B, the term “Seller A” was queried using the search query textbox 205. In this example, the selected content item is a video advertisement 220B for an Example Online Retailer. The annotation 220B appears generally along the right of the video player 215. The annotation 220B also lists two of the products, product A and product B, sold by the Example Online Retailer and includes a description and price of the respective product. The product description and price can be accessed from pre- existing data provided by the content provider 115. In annotation 220B, each of the product names may be hyperlinks (as indicated in underline) to the respective webpage that contains more information about the respective product.

In FIG. 2C, the term “Book Z” was queried using the search query textbox 205. In this example, the selected content item is a video advertisement 220C for an Example Book Store. The annotation 220C appears generally at the bottom left corner of the video player 215. The annotation 220C is a display annotation indicating that the list price of any product will be discounted between May 3 to May 5 by 20%. This information can be accessed from pre-existing data provided by the content provider 115. Unlike annotations 220A and 220B, annotation 220C does not include a hyperlink for more information at another webpage.

In some implementations, the annotation type selection module 135 can be configured to identify, for a content provider having a campaign, a setting to automatically enhance one or more content items for the campaign based on pre-existing data. Referring briefly to FIG. 3, FIG. 3 is a display depicting a user interface for an advertisement campaign manager, according to an illustrative implementation. Advertisement campaign manager graphical user interface (GUI) 300 for the advertisement campaign manager can include a campaign settings window 305, one or more other settings 310, and an auto-enhance advertisement setting 315, and start campaign button 320. Using the advertisement campaign manager GUI, the content provider 115 can enter various information (through other interfaces not depicted), such as specifying which pre-existing data regarding the products and services advertised by the content provider 115 to use for the campaign. The campaign settings window 305 can list a number of settings 310 and 315 along with check boxes generally to the left of the settings listed. The one or more other settings 310 can include settings regarding specification of location, time, and remarketing. In this example, once the auto-enhance advertisement setting 315 has been checked and the start campaign button 320 has been clicked by the content provider 115, the annotation type selection module 135 can identify the auto-enhancement setting 315 as being checked as a setting to automatically enhance the one or more content items for the campaign based on pre-existing data.

The annotation type selection module 135 can be configured identify the one or more candidate annotations types from a plurality of sources. In some implementations, the annotation type selection module 135 can be configured to identify third-party content from a database 140 responsive to selection of content item. In some implementations, the annotation type selection module 135 can be configured to identify the one or more candidate annotation types based on the third-party content. In some implementations, the annotation type selection module 135 can be configured to identify the third-party content from the databased based on content item auction parameters. For example, suppose the content item selection module 130 has selected the content item for a particular musical in the local area to display on the end user computing device 125 based in part on receiving a search query for the particular musical. Based on the search query and a location identifier of the end user computing device 125, the annotation type selection module 135 can identify a third party database 140 that contains locations, times, and other information regarding musicals performed across the country. Continuing this example, the annotation type selection module 135 can identify an annotation displaying the times that the particular music is being performed in a theatre in the local area from the identified third-party database 140 as the one of the one or more candidate annotation types.

In some implementations, the annotation type selection module 135 can be configured to identify the one or more candidate annotation types based on pre-existing data, responsive to identifying the setting to automatically enhance the one or more content items for the campaign. Pre-existing data can include data from another advertisement campaign of the content provider 115. In some implementations, the content provider 115 or content publisher 120 can input or generate a source data feed. The source data feed can include, for example, information that can be used to provide dynamic advertising. In this example, by checking the auto-enhancement setting 315, dynamic advertising can be provided to video advertisements by allowing advertisements of the video advertisement to utilize the source data feed to generate annotations. In another example, suppose the content provider 115 is a sports goods store, has checked the auto-enhancement advertisement setting 315 on the campaign settings window 305, and has entered pre-existing data regarding the sports goods store's various products, prices of the various products, and the location of sports goods stores, among others either through the current campaign or another pre-existing campaign. Based on the auto-enhancement advertisement setting 315 being checked by the content provider 115, the annotation type selection module 135 can identify a click for directions annotations to one of the sports goods store's stores, a display of one of a hockey stick sold by the sports goods store, and a click to call annotation listing one phone number of the sports goods store to allow the end user computing device 125 to initiate a phone call, among others.

In some implementations, the annotation type selection module 135 can be configured to identify pre-existing data from one or more campaigns of the content provider 115. In some implementations, the one or more campaigns can include campaigns previously setup by the content provider 115. In some implementations, the pre-existing data can include an information feed or web feed provided by the content provider 115. In some implementations, the database 140 can include the pre-existing data to be accessed by the annotation type selection module 135.

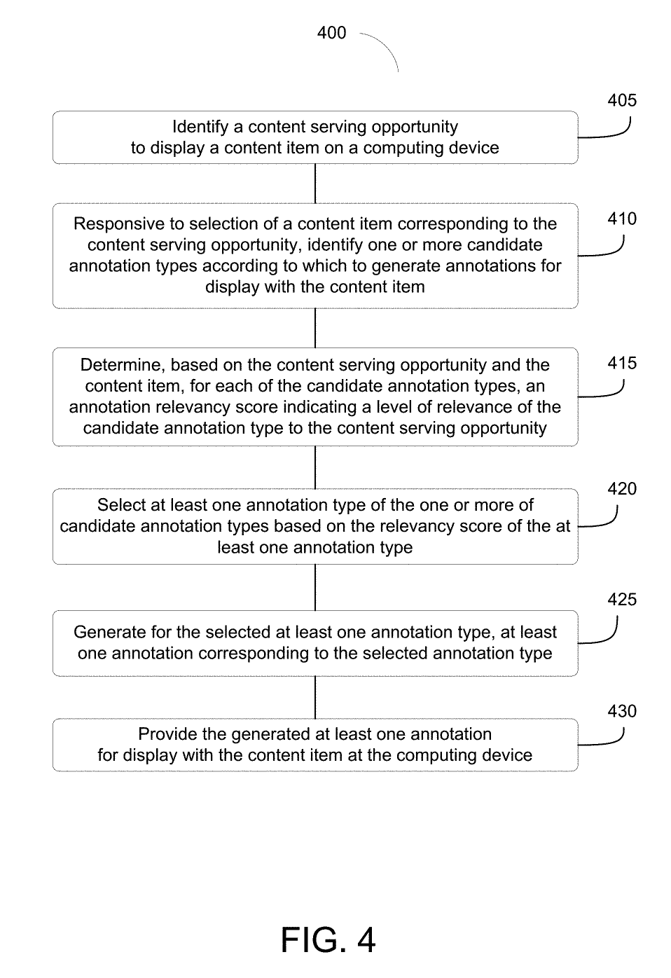

FIG. 4 is a flow diagram depicting a method 400 of auto-enhancing content items. The functionality described herein with respect to method 400 can be performed or otherwise executed by the data processing system 110 or the various modules of the data processing system 110 shown in FIG. 1. In brief overview, the data processing system can identify a content serving opportunity to display a content item on a computing device (BLOCK 405). The data processing system can, responsive to selection of a content item corresponding to the content serving opportunity, identify one or more candidate annotation types according to which to generate annotations for display with the content item (BLOCK 410). The data processing system can determine, based on the content serving opportunity and the content item, for each of the candidate annotation types, an annotation type relevancy score indicating a level of relevance of the candidate annotation type to the content serving opportunity (BLOCK 415). The data processing system can select at least one annotation type of the one or more of candidate annotation types based on the relevancy score of the at least one annotation type (BLOCK 420). The data processing system can generate for the selected at least one annotation type, at least one annotation corresponding to the selected annotation type, the at least one annotation including information related to the content item (BLOCK 425). The data processing system can provide the generated at least one annotation for display with the content item at the computing device.

The data processing system can identify a content serving opportunity to display a content item on an end user computing device (BLOCK 405). The content item can include a video ad, a static ad, a text ad, a dynamic ad, among others. The content item can be displayed on a display of the end user computing device. In some implementations, the content item can be displayed in a content slot or ad slot in a web page that is displayed at a display of the end user computing device. The content serving opportunity can include any parameter that may be used to select at least one content item from a plurality of content items for display on the end user computing device. In some implementations, a content serving opportunity relates to any opportunity to serve an ad. The content serving opportunity can include one or more parameters that can be used by a server of the ad selection system to select an ad for display. The parameters can be specific to the request. Examples of parameters that can be used can include a time of day, a type of device, an identifier associated with the request, information associated with primary content with which to serve the ad, and one or more keywords corresponding to the opportunity, among others. In some implementations, when a user requests to receive content, a request to identify one or more ads for serving with the content can be generated. The requests can include information about the webpage on which to serve the ad, information about the user to whom the ad is to be served, information about the device on which the ad is to be served, geographic information of the user, and interests of the user, among others.

In some implementations, the data processing system can determine an existence of a content serving opportunity to display a content item, such as an ad, on an end user computing device, responsive to receiving the request for content from the end user computing device. For example, when the end user computing device sends a request for an online document that includes content slots to the data processing system, the data processing system can determine that there exists a content serving opportunity to display a content item in each of the content slots. Responsive to determining the existence of the content serving opportunity to display the content item on the end user computing device, the data processing system can identify the content serving opportunity to display the content item on the end user computing device.

In some implementations, the data processing system can identify the content serving opportunity based on content item auction parameters and the primary content on which the content item is to be displayed. The content item auction parameters can include bid values for various content providers to place content items, such as advertisements, on a web page of the content publisher. Content item auction parameters can also include specified search queries for which to serve the content item with. The primary content on which the content item is to be displayed can include an information resource, which can include one or more of an online document, web page, mobile app page, video player, among others. For example, the data processing system can select at least one content item of a plurality of content items based on the bid values for each of the content items and the primary content on which the content item is to be displayed. In this example, if content item A is about a new movie and content item B is about a new skateboard, and the primary content on which the content item is to be displayed is a film critic blog, the data processing system can select content item A about the new movie based on the content of the film critic blog by using keyword extraction algorithms or the like.

In some implementations, the content serving opportunity can include at least one of a device type of the end user computing device, a location identifier of the end user computing device, a time of day, and an industry relating to the content provider. For example, suppose the device type of the end user computing device is a mobile smartphone, the location identifier of the end user computing device indicates that the mobile smartphone is in the financial district of a large metropolitan municipality, and the time of day is 11:35 am. Further suppose that there is content item A associated with a food truck and content item B associated with tractors for farms. In this example, the data processing system can identify the content serving opportunity for content item A to serve to the mobile smartphone as including the location of the mobile smartphone being in the financial district of a large metropolitan municipality and the time of day being 11:35 am.

Responsive to selection of a content item corresponding to the content serving opportunity, the data processing system can identify one or more candidate annotation types according to which to generate annotations for display with the content item (BLOCK 410). The one or more candidate annotation types can include at least one of a click to call annotation to allow the end user computing device to initiate a phone call, a click for directions annotation to display a map having directions on the end user computing device, a click to order annotation to initiate a purchase order on the end user computing device, and a display annotation of the products or services advertised by the content provider, among others.

The data processing system can identify one or more candidate annotation types based on annotation type selection parameters. The annotation type selection parameters can include one or more parameters that can be used by the data processing system to identify or otherwise select at least one of the one or more candidate annotation types. In some implementations, the annotation type selection parameters can include any information relevant to identifying or otherwise selection the one or more candidate annotation types and the content of the one or more annotations corresponding to the respective annotation types. In some implementations, the annotation type selection parameters can include primary content, identifier information, and request specific parameters. Identifier information can include device identifier, location identifier, account identifier, remarketing list data in among others. Request specific parameters can include time of day, day of week, and time of year, search query leading to the request, among others. In some implementations, the request specific parameters can be generated by the data processing system, when a user requests to receive content or when the server of the ad selection system selects a content item for display.

In some implementations, the data processing system can access the annotation type selection parameters from a database, responsive to the selection of the content item corresponding to the content serving opportunity. In some implementations, the data processing system can determine the annotation type selection parameters based on the content serving opportunity. In some implementations, responsive to the selection of the content item corresponding to the content serving opportunity, the data processing system can port over, retrieve, or otherwise access the content serving opportunity as the annotation type selection parameters. For example, suppose the server of the ad selection system has selected an advertisement for hockey team “Z” located in state XY. Further suppose that the content serving parameters indicate that the primary content is a sports related website, the location identifier indicates that the device that the advertisement is served is in state XY, and the month of year is winter. In this example, the data processing system can identically port over the content serving parameters as the annotation type selection parameters.

The data processing system can be configured to determine, based on the content serving opportunity and the content item, for each of the candidate annotation types, an annotation type relevancy score indicating a level of relevance of the candidate annotation type to the content serving opportunity (BLOCK 415). In some implementations, the data processing system can be configured to determine the annotation type relevancy score based on the content item, annotation type selection parameters, primary content on which the content item is to be displayed, and the specifications of the end user computing device, among others, or any combination thereof. In some implementations, data processing system can be configured to assign or otherwise determine a numerical weight based on a function of the content item, annotation type selection parameters, primary content on which the content item is to be displayed, and the specifications of the end user computing device.

In some implementations, the data processing system can be configured to determine the annotation type relevancy score based on the content item and the candidate annotation type. For example, suppose the content item is a static text advertisement and includes a reference to a particular menu item at a restaurant franchise. Further suppose that the candidate annotation type is a display annotation containing short text descriptions of other menu items. In this example, data processing system can determine the annotation type relevancy score based on the correlation between the contents of the content item and the candidate annotation type by correlating similar or identical words and phrases on the content item and the candidate annotation type using semantic analysis algorithms.

In some implementations, the data processing system can be configured to determine the annotation type relevancy score based on the annotation type selection parameters. For example, suppose the content serving opportunity includes a search query specific to the request for content for “directions to ski park Y.” In this example, the data processing system can assign a higher annotation type relevancy score to a click for directions annotation type than a display annotation type based on the search query included in the content serving opportunity.

In some implementations, the data processing system can be configured to determine the annotation type relevancy score based on the primary content on which the content item is to be displayed. In some implementations, the data processing system can be configured to determine the type of primary content. For example, suppose the primary content is a furniture store's webpage and the content item selected for display on the primary content are advertisements for lamps displayed. In this example, the data processing system can determine that the furniture store's webpage is a primary content of the content publisher associated with the content provider. Based on this determination, the data processing system can assign a higher annotation type relevancy score to a click to order annotation.

In some implementations, the data processing system can be configured to identify the specifications of the end user computing device. The specifications of the end user computing device can include a device identifier associated with the end user computing device, location identifier associated with the end user computing device, device type of the end user computing device, and device capability of the end user computing device, among others. The device capability or capabilities of the end user computing device can include any property of the end user computing device itself, such as the operating system, hardware specifications, ability to make phone calls, display window size, and whether the audio has been muted, among others.

In some implementations, the data processing system can be configured to assign a numerical weight for each of the one or more candidate annotation types based on the specifications of the end user computing device and the respective candidate annotation type. For example, suppose for an advertisement of a jewelry store, candidate annotation type A is a click to call annotation to allow the computing device to initialize a phone call and candidate annotation type B is a display of merchandise sold at the jewelry store. Further suppose the primary content on which the content item is to be displayed is an online newspaper article, and the device type of the end user computing device is a tablet without telephone call capabilities. In this example, the data processing system can determine the annotation type relevancy score for display of merchandise sold at the jewelry store and the annotation type relevancy score for the click to call annotation, using a greater numerical weight for the display of merchandise sold at the jewelry store based on the device of the end user computing device being a tablet without telephone call capabilities.

In some implementations, the data processing system can determine a predicted conversion rate for each of the candidate annotation types. The predicted conversion rate can include one or more of a predicted click through rate, a predicted view through rate, among others. The predicted click through rate can include a function of an expected number of clicks and an expected number of impressions, among others. The predicted view through rate can include a function of an expected post-impression response rate and an expected number of impressions, among others. In some implementations, the data processing system can determine the annotation type relevancy score for each of the candidate annotation types based on the predicted conversion rate for the respective candidate annotation type.

In some implementations, the data processing system can determine a predicted conversion rate for each of the candidate annotation types based on prior performance metrics. In some implementations, the data processing system can access the prior performance metrics from the database. In some implementations, the data processing system can access prior performance metrics corresponding to the each of the candidate annotation types. In some implementations, the prior performance metrics corresponding to the respective candidate annotation type can be associated with at least one of the specifications of the end user computing device.

In some implementations, the data processing system can adjust or otherwise apply a multiplicative or additive factor to the prior performance metrics corresponding to the respective candidate annotation type based on at least one of the specifications of the end user computing device to determine the predicted conversion rate. For example, suppose the content item selected is for a televised comedy show, the location identifier of the end user computing device indicates that the end user computing device is in a suburban area, and the time of day is 10:00 pm. Further suppose that prior performance metrics of the identified candidate annotation type indicate that the view through rate of the candidate annotation type is 0.3% across all locations where the candidate annotation type was previously displayed with the selected content item. In addition, suppose that the television viewing behavior statistics varies throughout different times of the day. In this example, the data processing system can determine the predicted conversion rate based on the prior performance metric of 0.3% view through rate adjusted by the television viewing behavior statistics of the suburban area.

In some implementations, the data processing system can determine the predicted conversion rate for each of the candidate annotation types based on a correlation between the primary content associated with the content item and content of each of the candidate annotation types. In some implementations, that data processing system can access the database for a plurality of correlated words. For example, suppose the primary content includes an article that includes several instances of the phrase “deep dish pizza” and the data processing system has already selected a content item for a pizza chain. Further suppose that candidate annotation type A is a click for directions annotation and that candidate annotation type B is a display annotation with the pizza chain's various menu items. The data processing system can determine that the correlation between the phrase “deep dish pizza” included in the primary content to the content of candidate annotation type A and the content of candidate annotation type B based on the information contained in the candidate annotation type A and candidate annotation type B. The data processing system can determine the correlation between the search query and the information contained in the candidate annotation types using various algorithms such as semantic analysis, semantic correlation, sparse word graphs, and topic modeling, among others. In this example, the data processing system can access the database for a list of words or phrases correlated with the phrase “deep dish pizza.”

The data processing system can select at least one annotation type of the one or more of candidate annotation types based on the relevancy score of the at least one annotation type (BLOCK 420). In some implementations, the data processing system can rank the one or more candidate annotation types based on the relevancy scores for each of the one or more candidate annotation types. In some implementations, responsive to ranking the one or more candidate annotation types based on the relevancy scores for each of the one or more candidate annotation types, the data processing system can select at least one annotation type of the one or more of candidate annotation types with the higher annotation type relevancy scores.

The data processing system can generate, create, or otherwise render, for the selected at least one annotation type, at least one annotation corresponding to the selected annotation type (BLOCK 425). The at least one annotation can include information related to the content item. The information can be received from a source data feed of the content provider that is associated with a previously established content serving campaign. In some implementations, the content item can belong to or be otherwise associated with a second content serving campaign different from the previously established content serving campaign. In some implementations, the data processing system can render, for display, the at least one annotation corresponding to the selected annotation type.

In some implementations, the data processing system can access at least one annotation template stored at the database to generate or render the selected at least one annotation. In some implementations, the at least one annotation template can specify location and size of the annotation to be displayed on the content item and a type of content item on which the annotation is to be displayed. For example, suppose a template specifies that the annotation is to be displayed generally along the top of a content item and the type of content item on which the annotation is to be displayed is a static banner advertisement. Further suppose that the selected candidate annotation type is a click to call annotation. In this example, the data processing system can render the a click to call annotation with the phone number of the content provider based on the corresponding selected candidate annotation type to be displayed along the top of the static banner advertisement.

The data processing system can provide the generated at least one annotation for display with the content item at the end user computing device (BLOCK 430). For example, suppose there is a web browser that includes search query textbox, video, video player, a video advertisement, annotation, a list of videos, and third party content displayed at a display of the end user computing device. The search query textbox can receive input for a search query for content. The video player can play the video using buttons generally along the bottom of the video player interface. The video can include video advertisements. Video advertisements can include annotations. Videos can include hyperlinks to other videos depicted therein. Third party content can include content items provided by the content provider or content publisher, and can include a static advertisement, animated advertisement, another video advertisement, and audiovisual advertisement, among others. In some implementations, the video advertisements can be selected outside the context of search querying.

In some implementations, the data processing system can be configured to retrieve the generated at least one annotation for display with the content item at the end user computing device, responsive to receiving a request for content or responsive to the selection of the content item. In some implementations, the data processing system can be configured to provide each of the generated annotations for display with the content item at the end user computing device at predetermined times.

In some implementations, data processing system can be configured to provide the generated at least one annotation for display at different locations on the content item in accordance to the annotation template. In some implementations, the data processing system can be configured to identify the different locations based on edge detection of the underlying image of the content item. For example, the data processing system can identify negative space, such as white space or black space, within the content item as a location at which to provide the generated annotation. In some implementations, the data processing system can be configured to identify which of the different locations on the content item has the highest predicted click through rate. For example, the data processing system can perform A/B testing and aggregate the results to determine highest predicted click through rate. In some implementations, the data processing system can be configured to select at least one of the different locations on the content item to provide the generated at least one annotation for display based on determined highest predicted click through rate.

In some implementations, the data processing system can identify, for a content provider having a campaign, a setting to automatically enhance one or more content items for the campaign based on pre-existing data. Advertisement campaign manager graphical user interface (GUI) can include a campaign settings window, one or more other settings, an auto-enhance advertisement setting, and start campaign button. Using the advertisement campaign manager GUI, the content provider can enter various information (through other interfaces not depicted), such as specifying which pre-existing data regarding the products and services advertised by the content provider to use for the campaign. The campaign settings window can list a number of settings and along with check boxes generally to the left of the settings listed. The one or more other settings can include settings regarding specification of location, time, and remarketing. In this example, once the auto-enhance advertisement setting has been checked and the start campaign button has been clicked by the content provider, the data processing system can identify the auto-enhancement setting as being checked as a setting to automatically enhancement the one or more content items for the campaign based on pre-existing data.

The data processing system can be configured identify the one or more candidate annotations types from a plurality of sources. In some implementations, the data processing system can identify third-party content from a database responsive to selection of content item. In some implementations, the data processing system can identify the one or more candidate annotation types based on the third-party content. In some implementations, the data processing system can identify the third-party content from the databased based on content item auction parameters. For example, suppose the data processing system has selected the content item for a particular musical in the local area to display on the end user computing device based in part on receiving a search query for the particular musical. Based on the search query and a location identifier of the end user computing device, the data processing system can identify a third party database that contains locations, times, and other information regarding musicals performed across the country. Continuing this example, the data processing system can identify an annotation displaying the times that the particular music is being performed in a theatre in the local area from the identified third-party database as the one of the one or more candidate annotation types.

In some implementations, the data processing system can be configured to identify the one or more candidate annotation types based on pre-existing data, responsive to identifying the setting to automatically enhance the one or more content items for the campaign. Pre-existing data can include data from another advertisement campaign of the content provider. In some implementations, the content provider or content publisher can input or generate a source data feed. The source data feed can include, for example, information that can be used to provide dynamic advertising. In this example, by checking an auto-enhancement setting on the campaign manager, dynamic advertising can be provided to video advertisements by allowing advertisements of the video advertisement to utilize the source data feed to generate annotations. In another example, suppose the content provider is a sports goods store, has checked the auto-enhancement advertisement setting on the campaign settings window, and has entered pre-existing data regarding the sports goods store's various products, prices of the various products, and the location of sports goods stores, among others either through the current campaign or another pre-existing campaign. Based on the auto-enhancement advertisement setting being checked by the content provider, the data processing system can identify a click for directions annotations to one of the sports goods store's stores, a display of one of a hockey stick sold by the sports goods store, and a click to call annotation listing one phone number of the sports goods store to allow the end user computing device to initiate a phone call, among others.

In some implementations, the data processing system can be configured to identify pre-existing data from one or more campaigns of the content provider. In some implementations, the one or more campaigns can include campaigns previously setup by the content provider. In some implementations, the pre-existing data can include an information feed or web feed provided by the content provider. In some implementations, the database can include the pre-existing data to be accessed by the data processing system.

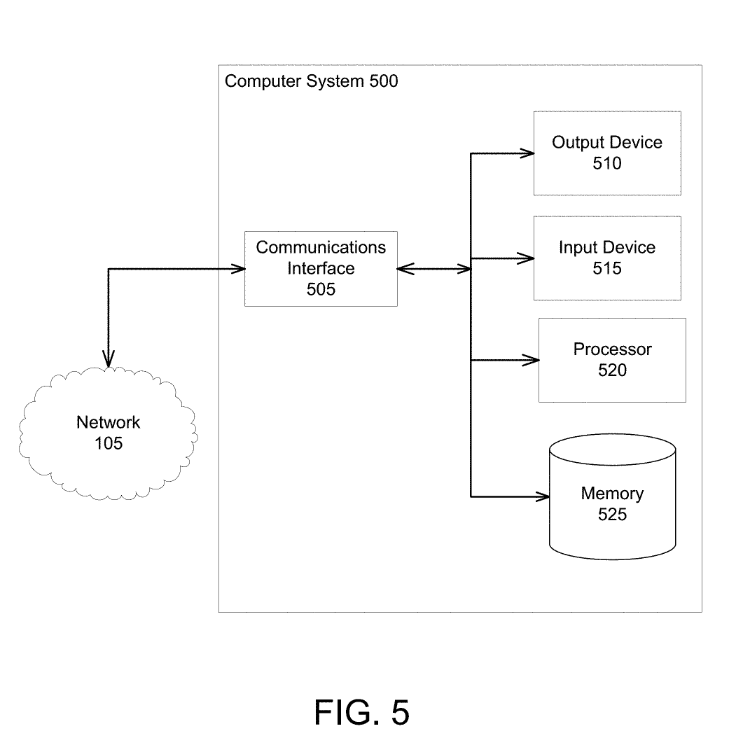

FIG. 5 shows the general architecture of an illustrative computer system 500 that may be employed to implement any of the computer systems discussed herein (including the system 110 and its components such as the content item selection module 130 and the annotation type selection module 135) in accordance with some implementations. The computer system 500 can be used to provide information via the network 105 for display. The computer system 500 of FIG. 5 comprises one or more processors 520 communicatively coupled to memory 525, one or more communications interfaces 505, and one or more output devices 510 (e.g., one or more display units) and one or more input devices 515. The processors 520 can be included in the data processing system 110 or the other components of the system 110 such as the content item selection module 130 and the annotation type selection module 135.

In the computer system 500 of FIG. 5, the memory 525 may comprise any computer-readable storage media, and may store computer instructions such as processor- executable instructions for implementing the various functionalities described herein for respective systems, as well as any data relating thereto, generated thereby, or received via the communications interface(s) or input device(s) (if present). Referring again to the system 110 of FIG. 1, the data processing system 110 can include the memory 525 to store information related to the availability of inventory of one or more content units, reservations of one or more content units, among others. The memory 525 can include the database 140. The processor(s) 520 shown in FIG. 5 may be used to execute instructions stored in the memory 525 and, in so doing, also may read from or write to the memory various information processed and or generated pursuant to execution of the instructions.

The processor 520 of the computer system 500 shown in FIG. 5 also may be communicatively coupled to or control the communications interface(s) 505 to transmit or receive various information pursuant to execution of instructions. For example, the communications interface(s) 505 may be coupled to a wired or wireless network, bus, or other communication means and may therefore allow the computer system 500 to transmit information to or receive information from other devices (e.g., other computer systems). While not shown explicitly in the system of FIG. 1, one or more communications interfaces facilitate information flow between the components of the system 50. In some implementations, the communications interface(s) may be configured (e.g., via various hardware components or software components) to provide a website as an access portal to at least some aspects of the computer system 500. Examples of communications interfaces 505 include user interfaces (e.g., web pages), through which the user can communicate with the data processing system 50.

The output devices 510 of the computer system 500 shown in FIG. 5 may be provided, for example, to allow various information to be viewed or otherwise perceived in connection with execution of the instructions. The input device(s) 515 may be provided, for example, to allow a user to make manual adjustments, make selections, enter data, or interact in any of a variety of manners with the processor during execution of the instructions. Additional information relating to a general computer system architecture that may be employed for various systems discussed herein is provided further herein.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing module configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

The operations described in this specification can be implemented as operations performed by a data processing apparatus on data stored on one or more computer-readable storage devices or received from other sources.

The terms “data processing apparatus”, “data processing system”, “user device” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The content item selection module 130 and the annotation type selection module 135 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 500 or system 110 can include clients and servers. For example, the data processing system 110 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the content item selection module 130 and the annotation type selection module 135 can be part of the data processing system 110, a single module, a logic device having one or more processing modules, one or more servers, or part of a search engine.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided herein relate to automatically enhancing online advertisements by inserting annotations for display, the systems and methods described herein can include applied to other environments. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method of automatically inserting annotations into content items, comprising:
receiving, by a data processing system including one or more processors, a request for content on an information resource at a client device, the request specifying a device type of the client device;
responsive to selection of a content item for the information resource, identifying, by the data processing system, one or more candidate annotation types according to which to generate annotations for display with the content item;
parsing, by the data processing system, the information resource and the content item to identify keywords on the information resource and the content item;
determining, for each candidate annotation type, based on applying a semantic analysis algorithm to the candidate annotation type and the keywords of the information resource and of the content item, by the data processing system, a relevancy score indicating a degree of semantic correlation among the candidate annotation type and the keywords of the information resource and of the content item;
adjusting, by the data processing system, the relevancy score for each candidate annotation type by a numerical weight selected from a plurality of predetermined numerical weights based on the device type of the client device and the candidate annotation type;
selecting, by the data processing system, at least one annotation type of the one or more of candidate annotation types based on the relevancy score of the at least one annotation type adjusted by the numerical weight selected based on the device type and the candidate annotation type;
generating, by the data processing system, for the selected at least one annotation type, at least one annotation corresponding to the selected annotation type, the at least one annotation using information received from a first source data feed separate from a second source data feed for the content item of the content provider, the first source data feed established prior to the second source data feed; and
providing, by the data processing system, to the client device, the generated at least one annotation and the content item for display on the information resource at the client device.

2. The method of claim 1, further comprising:
identifying, by the data processing system, the information from the first source data feed based on the selected content item,
wherein identifying one or more candidate annotation types according to which to generate annotations for display with the content item further includes identifying the one or more candidate annotation types based on the information from the first source data feed.

3. The method of claim 2, wherein identifying the information from the first source data feed based on the selected content item includes identifying the information from the first source data feed based on content item selection parameters included in the request.

4. The method of claim 1, further comprising:
identifying, by the data processing system, for the content provider, a setting to automatically insert annotations in one or more content items based on pre-existing data,
wherein identifying the one or more candidate annotation types includes identifying the one or more candidate annotation types, responsive to identifying the setting to automatically insert the annotations in the one or more content items, based on the pre-existing data.

5. The method of claim 1, wherein the one or more of the candidate annotation types includes at least one of a click to call annotation to allow the client device to initiate a phone call, a click for directions annotation to display a map having directions on the client device, and a click to order annotation to initiate a purchase order on the client device.

6. The method of claim 1, wherein the content item includes a video content item.

7. The method of claim 1, wherein the request includes selection parameters and primary content of the information resource on which the content item is to be displayed.

8. The method of claim 7, wherein the request includes a location identifier of the client device and a temporal identifier.

9. The method of claim 1, wherein determining the relevancy score includes:
determining a predicted conversion rate for each of the candidate annotation types; and
determining the relevancy score for each of the candidate annotation types based the predicted conversion rate for the respective candidate annotation type.

10. The method of claim 9, wherein determining the predicted conversion rate for each of the candidate annotation types includes determining the predicted conversion rate for each of the candidate annotation types based on a semantic correlation between a primary content associated with the content item and content of each of the candidate annotation types.

11. A system for automatically enhancing online advertisements by inserting annotations, comprising:
a data processing system having one or more processors that:
receives a request for content on an information resource at a client device, the request specifying a device type of the client device;
responsive to selection of a content item for the information resource, identifies one or more candidate annotation types according to which to generate annotations for display with the content item;
parses the information resource and the content item to identify keywords on the information resource and the content item;
determines, for each candidate annotation type, based on applying a semantic analysis algorithm to the candidate annotation type and the keywords of the information resource and of the content item, a relevancy score indicating a degree of semantic correlation among the candidate annotation type and the keywords of the information resource and of the content item;
adjusts the relevancy score for each candidate annotation type by a numerical weight selected from a plurality of predetermined numerical weights based on the device type of the client device and the candidate annotation type;
selects at least one annotation type of the one or more of candidate annotation types based on the relevancy score of the at least one annotation type adjusted by the numerical weight selected based on the device type and the candidate annotation type;
generates for the selected at least one annotation type, at least one annotation corresponding to the selected annotation type, the at least one annotation using information received from a first source data feed separate from a second source data feed for the content item of the content provider, the first source data feed established prior to the second source data feed; and
provides, to the client device, the generated at least one annotation and the content item for display on the information resource at the client device.

12. The system of claim 11, wherein the data processing system further:
identify the information from the first source data feed based on the selected content item,
wherein identifying one or more candidate annotation types according to which to generate annotations for display with the content item further includes identifying the one or more candidate annotation types based on the information from the first source data feed.

13. The system of claim 12, wherein the data processing system identifies the third-party content from the database based on content item auction parameters.

14. The system of claim 11, wherein the data processing system further:
identifies for a content provider, a setting to insert annotations in one or more content items based on pre-existing data,
identifies the one or more candidate annotation types, responsive to identifying the setting to automatically insert the annotations the one or more content items, based on the pre- existing data.

15. The system of claim 11, wherein the one or more of the candidate annotation types includes at least one of a click to call annotation to allow the client device to initiate a phone call, a click for directions annotation to display a map having directions on the client device, and a click to order annotation to initiate a purchase order on the client device.

16. The system of claim 11, wherein the content item includes a video content item.

17. The method of claim 11, wherein the request includes selection parameters and primary content of the information resource on which the content item is to be displayed.

18. The method of claim 17, wherein the request includes a location identifier of the client device and a temporal identifier.

19. The system of claim 11, wherein the data processing system:
determines a predicted conversion rate for each of the candidate annotation types; and
determines the relevancy score for each of the candidate annotation types based the predicted conversion rate for the respective candidate annotation type.

20. The system of claim 19, wherein the data processing system determines the predicted conversion rate for each of the candidate annotation types based on a semantic correlation between a primary content associated with the content item and content of each of the candidate annotation types.
